(19) United States
(12) Patent Application Publication
(10) Pub. No.: US 2008/0051482 A1
(43) Pub. Date: Feb. 28, 2008

(54) Foams Containing Silicon

(75) Inventors: Volker Stanjek, Muenchen (DE); Oliver Schaefer, Burghausen (DE); Bernd Pachaly, Mehring (DE)

Correspondence Address: BROOKS KUSHMAN P.C., 1000 TOWN CENTER, TWENTY-SECOND FLOOR, SOUTHFIELD, MI, 48075, US

(73) Assignee: CONSORTIUM FUER ELEKTROCHEMISCHE INDUSTRIE GMBH, Muenchen (DE)

(21) Appl. No.: 11/854,567

(22) Filed: Sep. 13, 2007

Related U.S. Application Data
(63) Continuation of application No. 10/506,025, filed on Aug. 27, 2004, now abandoned.

(30) Foreign Application Priority Data
Mar. 21, 2002 (DE) 102 12 658.5

(51) Int. Cl. C08G 77/04; C08J 9/00

(52) U.S. Cl. 521/154

(57) ABSTRACT

Both flexible and rigid foams may be prepared by reacting di- or polyisocyanates with organopolysiloxanes which are prepared by reaction of silanol-terminated organopolysiloxanes with organosilicon compounds containing alkyleneoxy or alkylenamino groups bonded on both ends to silicon, thus resulting in organopolysiloxanes having 95% or more of aminoalkyl or hydroxyalkyl terminal groups.

This application is a continuation of U.S. application Ser. No. 10/506,025 filed Aug. 27, 2004 as a U.S. National Phase of PCT/EP03/00702 filed Jan. 23, 2003, and claims priority to German Application No. 102 12 658.5 filed Mar. 21, 2002.

### BACKGROUND OF THE INVENTION

1. Field of the Invention

The invention relates to foamable compositions comprising aminoalkyl- or hydroxyalkyl-terminated organopolysiloxanes, diisocyanates or polyisocyanates and blowing agents and to foams which can be produced therefrom.

2. Background Art

Both pure silicone foams and also polyurethane foams produced from organic polyols and diisocyanates or polyisocyanates have been known for a long time. However, each of these two groups of materials has specific advantages and disadvantages. Thus, although silicone foams generally have good resistance to high and low temperatures, they at the same time have a comparatively high density and only a very moderate mechanical property profile. Polyurethane foams, on the other hand, usually have excellent mechanical properties, both in the case of rigid polyurethane foams and in the case of flexible polyurethane foams. However, a disadvantage of the many polyurethane foams is flammability which is unsatisfactory for many applications and which can only be brought to a satisfactory level by means of large amounts of added fire retardants, if this is possible at all.

The use of silicone-polyurethane copolymers, i.e. polysiloxanes which also contain polyurethane and/or urea units, should thus make it possible to develop novel foams which have new combinations of properties tailored precisely to the respective application.

DE 41 08 326 C1 describes silicone foams which can be produced by reaction of hydroxyalkyl-functional polysiloxanes with diisocyanates or polyisocyanates. Crosslinking of the silicones occurs during foam formation. Water serves as blowing agent by reacting with the isocyanates used in excess to liberate carbon dioxide and form urea units. However, the polysiloxanes used here are linear polysiloxanes which, owing to the production methods previously available are only partly terminated by hydroxyalkyl groups and still have a proportion of chain ends which consist of —Si(CH₃)₂OH groups. Only flexible, elastic foams can be produced from these materials. The production of rigid foams is not possible using such prepolymers. Thus, even when using short-chain polyorganosiloxanes having only 10-12 chain atoms and a large isocyanate excess (use of up to 600 g of diphenylmethane 4,4-diisocyanate per 1,000 g of polyorganosiloxane), only flexible foams can be produced. Furthermore, the silicone foams produced by this method are not completely tack-free.

The reaction of hydroxyalkyl- or aminoalkyl-terminated polysiloxanes with diisocyanates or polyisocyanates is also known from further literature references, e.g. from U.S. Pat. No. 5,512,650 or WO 97/40103. However, this reaction has not been described for the production of foams but exclusively for the preparation of elastomers or prepolymers for hot-melt or sealant applications. Furthermore, the compounds described there are, owing to their high molar masses and thus very high viscosities, not suitable for use in a process for producing foams from prepolymers in which crosslinking of the prepolymers is to occur only during foam formation and at low temperatures.

### SUMMARY OF THE INVENTION

It has now been surprisingly and unexpectedly discovered that both flexible and rigid foams may be prepared by reacting di- or polyisocyanates with organopolysiloxanes which are prepared by reaction of silanol-terminated organopolysiloxanes with organosilicon compounds containing alkyleneoxy or alkyleneamino groups bonded on both ends to silicon, thus resulting in organopolysiloxanes having 95% or more of aminoalkyl or hydroxyalkyl terminal groups. These and other objects are achieved by the invention.

### DETAILS DESCRIPTION OF THE PREFERRED EMBODIMENT(S)

The present invention provides foamable compositions comprising the constituents

(A) linear or branched organopolysiloxanes in which at least 95% of the chain ends are terminated by aminoalkyl or hydroxyalkyl groups of the general formula (1)
—O—SiR¹₂O—SiR²₂—R³-Z (1)
and which can be prepared by reacting linear or branched organopolysiloxanes having end groups of the general formula (2)
—O—SiR¹₂—OH (2),
with organosilicon compounds composed of structural elements of the general formula (3),
—[SiR²₂—R³—Y—]ₖ (3)
where
R¹ and R² are each a monovalent, unsubstituted or —CN or halogen-substituted C₁-C₁₂-hydrocarbon radical in which one or more nonadjacent methylene units can be replaced by —O— units,
R³ is a divalent, unsubstituted or cyano- or halogen-substituted C₁-C₁₂-hydrocarbon radical,
Z is an OH or NH₂ group,
Y is an oxygen atom or an NR⁴ radical,
R⁴ is a hydrogen atom or a further radical of the general formula (3) in which k is 1 and Y is an NH₂ group, and
k is an integer from 1 to 1 000,
   (B) diisocyanates or polyisocyanates and
   (C) blowing agents.

During foaming of the foamable compositions, foam formation occurs by means of reaction of the organopolysiloxanes (A) with diisocyanates or polyisocyanates (B). Crosslinking of the polysiloxane prepolymers occurs only during foam formation, so that it is possible to use low-viscosity materials and foam formation can be carried out even at room temperature. The foams produced have an excellent mechanical property profile.

Preference is here given to using organopolysiloxanes (A) in which at least 97%, in particular at least 99%, of the chain ends are terminated by aminoalkyl or hydroxyalkyl groups of the general formula (1). Both aminoalkyl and hydroxyalkyl groups of the general formula (1) may be present in a molecule of organopolysiloxane (A).

As radicals R¹ and R², preference is given to unbranched alkyl groups, preferably those having from 1 to 6 carbon atoms, or aromatic hydrocarbons, e.g. unsubstituted or C₁-C₆-alkyl-, —CN—, or halogen-substituted phenyl radicals. Particularly preferred radicals R¹ and R² are ethyl, methyl or phenyl groups. The two radicals R¹ and R² on a silicon atom may be identical or different, but they are generally identical.

The radical R³ is preferably unsubstituted. Radicals R³ are, in particular, linear alkylene chains having from 1 to 6, preferably 3 or 4, carbon atoms or cyclic hydrocarbon radicals. Particular preference is given to n-propylene chains.

k is preferably an integer from 1 to 100, in particular from 2 to 50.

The degree of polymerization n of the polyorganosiloxane chain (A) can be up to 10 000, but preference is given to using polyorganosiloxanes having a chain length n of from 5 to 100. As polysiloxanes (A), preference is given to using linear organopolysiloxanes (A), in particular those of the general formula (4)
Z—R³—SiR²₂—O—SiR¹₂—O—[SiR^{l}₂O]ₘ—SiR²₂—R³-Z (4).

A particularly preferred skeleton for the hydroxyalkyl- or aminoalkyl-functional organopolysiloxanes (A) is the polydimethylsiloxane chain.

The linear organopolysiloxanes (A) of the general formula (4) are prepared from organopolysiloxanes of the general formula (5)
H—O[—SiR¹₂O]ₘ—H (5)
with organosilicon compounds composed of structural elements of the general formula (3).

In the general formulae (4) and (5),
m is an integer from 1 to 10,000 and
R¹, R², R³ and Z are as defined above.

The organosilicon compounds composed of structural elements of the general formula (3) can be cyclic monomers (k=1), dimers, oligomers or polymers. Preference is given to using the compounds of the formulae (6) and (7) 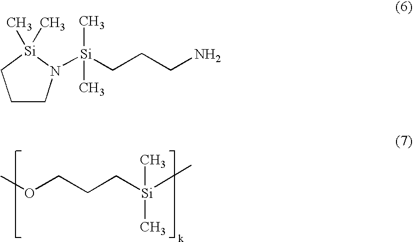
where
k is an integer of at least 2.

If organosilicon compounds in which Y═R⁴, for example the compound of the formula (6), are used, the termination of the silicone chains preferably proceeds to completion even at room temperature and preferably without addition of a catalyst (K).

If organosilicon compounds in which Y=oxygen, for example those of the formula (7), used, the reaction preferably occurs at temperatures of from 0° C. to 150° C., preferably in the presence of a catalyst (K).

As catalysts (K), preference is given to using acidic or basic compounds, e.g. partially esterified phosphoric acids, carboxylic acids, partially esterified carboxylic acids, alkylammonium hydroxides, ammonium alkoxides, alkylammonium fluorides or amine bases, organotin compounds, organozinc compounds, organotitanium compounds. After the reaction is complete, the catalysts (K) used are preferably deactivated by addition of anti-catalysts or catalyst poisons. In the case of acids and bases, deactivation can be carried out by means of a simple neutralization reaction.

The organosilicon compounds composed of structural elements of the general formula (3) are preferably used in the correct stoichiometric ratios in each case or in a slight excess of <5%. Under appropriate reaction conditions, it is possible to prepare hydroxyalkyl- or aminoalkyl-functional organopolysiloxanes (A) in which free Si—OH groups can no longer be detected by means of ¹H-NMR and ²⁹Si-NMR.

Furthermore, the reactions described also make it possible firstly to terminate part of the end groups of the general formula (2) with aminoalkyl groups of the general formula (1) and subsequently to terminate all remaining end groups of the general formula (2) of the organopolysiloxanes with hydroxyalkyl groups of the general formula (1). This gives organopolysiloxanes (A) which have both hydroxyalkyl and aminoalkyl end groups which have significantly different reactivities toward isocyanates and lead to foams in which the silicone chains are connected via both the urea units and urethane units to the remaining parts of the molecule. In this way, both the kinetics of foam curing and also the property profile of the cured foams can be modified within a wide range to match particular needs.

In the foamable compositions, one or more diorganoisocyanates or polyorganoisocyanates (B) are added to the organopolysiloxanes (A). All known diisocyanates or polyisocyanates come into question for this purpose. Preference is given to using diisocyanates or polyisocyanates of the general formula (8)
Q(NCO)ₙ (8),
where
Q is a k-functional aromatic or aliphatic hydrocarbon radical and
n is an integer of at least 2.

Examples of diisocyanates which can be used arediisocyanatodiphenylmethane (MDI), both in the form of crude or technical-grade MDI and in the form of pure 4,4′ or 2,4′ isomers or preparations made therefrom, tolylene diisocyanate (TDI) in the form of its various geometric isomers, diisocyanatonaphthalene (NDI), isophorone diisocyanate (IPDI) or hexamethylene diisocyanate (HDI). Examples of polyisocyanates are polymeric MDI (P-MDI), triphenylmethane triisocyanate or biuret triisocyanates. Diorganocyanates or polyorganoisocyanates (B) can be used individually or in admixture. The diisocyanates or polyisocyanates (B) are preferably used in an amount of at least 2 mol, in particular from 2 to 10 mol, per mole of organopolysiloxane (A). The molar excess of isocyanates is consumed in the reaction with water and possibly also in crosslinking via formation of biuret units. The diorganoisocyanates or polyorganoisocyanates (B) or preparations thereof which are used have an average of at least two isocyanate units per molecule, preferably 2-4 isocyanate units per molecule.

In the foamable compositions, blowing agents (C) are necessary for foam formation. The blowing agent (C) can be selected from among chemical blowing agents (CC) and physical blowing agents (CP). As chemical blowing agents (CC), preference is given to water. As physical blowing agents (CP), preference is given to low molecular weight hydrocarbons such as propane, butane or cyclopentane, dimethyl ether or fluorinated hydrocarbons such as 1,1-difluoroethane or 1,1,1,2-tetrafluoroethane. Physical blowing agents (CP) can be used to aid foam formation and thus obtain foams having an even lower density.

The foamable compositions can contain catalysts (D). As catalysts (D), it is possible to use, inter alia, organotin compounds. Examples are dibutyltin dilaurate, dioctyltin dilaurate, dibutyltin diacetate, dibutyltin dioctoate and dibutyltin bis(dodecyl mercaptide). It is also possible to use tin-free catalysts (D), e.g. organic titanates, iron catalysts such as organic iron compounds, organic and inorganic heavy metal compounds or tertiary amines. An example of an organic iron compound is iron(III) acetylacetonate. Examples of tertiary amines (D) are triethylamine, tributylamine, 1,4-diazabicyclo-[2.2.2]octane, N,N-bis(N,N-dimethyl-2-aminoethyl)methylamine, N,N-dimethylcyclohexylamine, N,N-dimethylphenylamine, bis(N,N-dimethylaminoethyl)ether, N,N-dimethyl-2-aminoethanol, N,N-dimethylaminopyridine, N,N,N,N-tetra-methyl(bis(2-aminoethyl)methylamine, 1,5-diazabicyclo-[4.3.0]non-5-ene, 1,8-diazabicyclo[5.4.0]undec-7-ene and N-ethylmorpholine.

Catalysts (D) can be used individually or in admixture. Preference is given to using a catalyst mixture (D) in which one catalyst (D) accelerates primarily the reaction of the hydroxyalkylsiloxane and the isocyanate while the second catalyst (D) preferentially catalyzes the reaction of the isocyanate with water. Appropriately chosen ratios of the concentrations of these catalysts (D) then make it possible to achieve a favourable ratio of the rate of foam formation to the rate of curing. Suitable catalyst mixtures (D) for this purpose are often mixtures containing at least one organotin compound and at least one tertiary amine. The weight ratio of the tertiary amines to the organotin compounds in the catalyst mixture (D) is preferably from 1:1 to 5:1.

Based on the foamable mixture, the catalyst (D) is preferably used in an amount of 0.1-6.0% by weight, particularly preferably in an amount of 0.3-4.0% by weight.

In many cases, it is advantageous to add foam stabilizers (E) to the foamable compositions. Foam stabilizers which can be used are, for example, the commercial silicone oligomers which are modified by polyether side chains and are also used for producing conventional polyurethane foams. The foam stabilizers are used in amounts of up to 6% by weight, preferably from 0.3 to 3% by weight, in each case based on the foamable compositions. The foam stabilizer (E) can simultaneously serve as solubilizer for the water. In addition, further solubilizers and/or emulsifiers can also be added.

Furthermore, the addition of cell regulators, thixotropic agents and/or plasticizers can be advantageous. To improve the fire resistance, flame retardants, e.g. phosphorus-containing compounds, especially phosphates and phosphonates, and halogenated polyesters and polyols or chloroparaffins, can additionally be added to the foamable compositions. It is also possible to incorporate all further additives customary for the modification of silicones in the foamable composition. Examples are fillers such as finely divided silica, carbon black, precipitated chalk or colourants.

The foamable compositions can be stored as one or more components prior to complete reaction of the constituents in foam formation.

2-Component compositions can be prepared by firstly producing a mixture of isocyanate-terminated organopolysiloxane-polyurethane prepolymers (PI) from organopolysiloxanes (A) and an excess of diisocyanates or polyisocyanates (B) for the first component. If exclusively aminoalkyl-functional silicones (A) are used, the reaction can proceed in the absence of catalysts; otherwise, the addition of an organotin or amine catalyst (D) is preferred. The mean molar mass and thus the viscosity of the prepolymers (P) can be adjusted via the size of the excess of diisocyanates or polyisocyanates (B). The isocyanate-terminated prepolymers (PI) may also still contain unreacted diisocyanates or polyisocyanates (B). Apart from the hydroxyalkyl- or aminoalkyl-functional polysiloxanes (A), small amounts of monomeric or oligomeric alcohols or amines having from 2 to 5 OH or NH groups per molecule, e.g. butanediol or pentaerythritol, can be used as isocyanate-reactive substances in this reaction. The preferred amounts of alcohols/amines used are from 0 to 30% by weight, based on the organopolysiloxanes (A). Catalysts (D) and, if desired, further additives are preferably subsequently added to this mixture and dissolved or emulsified in.

Foam formation and curing are subsequently achieved by mixing with the second component which comprises water as blowing agent (C) and, if desired, further blowing agents (C). Reaction of the components of these compositions gives rigid foams.

A further possible way of preparing 2-component or multicomponent systems is with the aid of a first component comprising a mixture, preferably an emulsion or solution, of silicone prepolymers (PS) and water. The second component, on the other hand, contains the diisocyanate or polyisocyanate (B). The catalyst (D) is preferably present in the first component. Furthermore, it is also possible to add the catalyst as third component only after mixing of the first two components. The latter procedure can be useful in order to achieve particularly good mixing of the first two components prior to commencement of foam formation.

Once again, use is made of silicone prepolymers (PS) whose chain ends are selected from among aminoalkyl and hydroxyalkyl groups of the general formula (1).

As silicone prepolymers (PS), it is possible to use either the pure organopolysiloxanes (A) or else OH-/NH-terminated siloxane prepolymers (PSB) which have been prepared by reaction of organopolysiloxanes (A) with a deficiency of diisocyanates or polyisocyanates (B). The mean molar mass of the prepolymers (PS) and thus the viscosity of the silicone/water emulsion can be adjusted via the size of the deficiency. Apart from the organopolysiloxanes (A), monomeric or oligomeric alcohols or amines having from 2 to 5 OH or NH groups, e.g. butanediol or pentaerythritol, can also be used as isocyanate-reactive substances in this reaction. The preferred amount of alcohols and/or amines used are from 0 to 30% by weight, based on the organopolysiloxanes (A). Furthermore, the same amounts of pure alcohols or amines having from 2 to 5 OH or NH groups per molecule can be present in the silicone/water emulsion.

An emulsifier or solubilizer which leads to stable silicone/water emulsions or silicone/water solutions is preferably added to the first component. Preference is given to using 0.05-0.5 g of emulsifier/solubilizer per 1 g of water. Examples of emulsifiers/solubilizers are fatty alcohol polyglycol ethers, fatty alcohol polyglycerol ethers, polyoxyethylene glyceryl esters or isotridecanol ethoxylate. Reaction of the components of these compositions gives flexible elastic foams.

In many cases, it is advantageous to add foam stabilizers (E). The foam stabilizers (E) can in principle be present in all components, but they are preferably present in the silicone/water component. Furthermore, it is possible to add a further, physical blowing agent (CP) to aid a foam formation and thus obtain foams having an even lower density. The blowing agent (C), too, can be present in all components. In addition, all components may contain further additives. Possibilities here are, inter alia, all of the abovementioned additives and further ingredients.

Furthermore, 1-component compositions can also be prepared by admixing the above-described isocyanate-terminated organopolysiloxane-polyurethane prepolymers (PI) with a physical blowing agent (CP), if desired a catalyst (D) and, if desired, further additives. After application of a 1-component foam produced in this way, it can then cure by reaction with atmospheric moisture. Curing of these compositions gives rigid foams.

The invention also provides the foams which can be obtained by curing of the 1-component compositions or by reaction of the components of multicomponent compositions. Furthermore, the present invention also provides the corresponding processes for producing the foams.

All the symbols in the above formulae have meanings which are independent of one another. The silicon atom is tetravalent in all formulae.

Unless indicated otherwise, all amounts and percentages are by weight, and all pressures are 0.10 MPa (abs.) and all temperatures are 20° C.

### Example 1

1,000 g of bishydroxy-terininated polydimethyl-siloxane having an Mₙ of 3,000 g/mol (determined by ¹H-NMR spectroscopy) are reacted at 80° C. with 79.4 g of poly-(1,1-dimethyl-1-sila-2-oxacyclopentane) having a viscosity of 40 mPas and 100 mg of formic acid. ¹H-NMR and ²⁹Si-NMR show that after a reaction time of 4 hours, all OH groups have been converted quantitatively into hydroxypropyl units. 500 mg of triethylamine are subsequently added to the reaction solution to deactivate the catalyst and the solution is briefly distilled at 80° C. under reduced pressure (5 mbar). This leaves pure bishydroxypropylpolydimethylsiloxane.

### Example 2

20 g of bishydroxypropylpolydimethylsiloxane as described in Example 1 are mixed with 0.05 g of dibutyltin dilaurate and 0.1 g of N,N,N,N-tetramethyl(bis(2-amino-ethyl)methylamine (Jeffcat® PMDETA from Huntsman Corp.) as catalysts, 0.15 g of emulsifier (Atlas® G-1300 from Deutsche ICI GmbH, Frankfurt a. Main), 0.4 g of foam stabilizer PC STAB EP 05 (Wacker Chemie GmbH, Germany) and 0.5 g of water. An emulsion is produced by means of a high-speed stator-rotor stirring device (Utraturrax®, 5 min at 15,000 rpm). The resulting emulsion has only a minimal residual turbidity. The emulsion is completely stable even after a number of days.

5.9 g of TDI are added to this emulsion and are mixed with the emulsion by means of a high-speed stator-rotor stirring device (Ultraturrax®, 30 sec at 15,000 rpm). After about 30-60 sec., an exothermic reaction and foam formation commence. The foam formation is concluded after about 30 sec., while evolution of heat continues for about another 60 sec and then slowly abates. The volume of the foam is 6-8 times the initial volume. A flexible, elastic foam having a fine pore structure is obtained.

### Example 3

20 g of bishydroxypropylpolydimethylsiloxane having a mean molar mass of about 700 g/mol are mixed with 0.1 g of dibutyltin dilaurate and 0.1 g of N,N,N,N-tetramethyl-(bis(2-aminoethyl)methylamine (Jeffcat® PMDETA from Huntsman Corp.) as catalysts, 0.2 g of emulsifier (Atlas® G-1300 from Deutsche ICI GmbH, Frankfurt a. Main), 0.4 g of foam stabilizer PC STAB EP 05 (Wacker Chemie GmbH, Germany) and 1.0 g of water. An emulsion is produced by means of a high-speed stator-rotor stirring device (Utraturrax®, 5 min at 15,000 rpm). The resulting emulsion has only a minimal residual turbidity. The emulsion is completely stable even after a number of days.

14.6 g of TDI are added to this emulsion and are mixed with the emulsion by means of a high-speed stator-rotor stirring device (Ultraturrax®, 30 sec at 15,000 rpm). After about 30 sec., a strongly exothermic reaction and foam formation commence. The foam formation is concluded after about 30 sec., while evolution of heat continues for about another 60 sec and then slowly abates. The volume of the foam is about 10 times the initial volume. A coarse-pored foam having an extremely high mechanical hardness is obtained.

### Example 4

20 g of bishydroxypropylpolydimethylsiloxane as described in Example 1 are admixed with 0.1 g of dibutyltin dilaurate as catalyst, 0.2 g of emulsifier (Atlas® G-1300 from Deutsche ICI GmbH, Frankfurt a. Main) and 1.28 g of polymeric MDI (Voranate® M220 from Dow Chemical) having a mean functionality of 2.7 and mixed with one another by means of a high-speed stator-rotor stirring device (Ultraturrax®) for about 5 minutes. During this time, the mixture heats up to about 60° C. Free isocyanate groups can then no longer be detected by means of IR spectroscopy. 0.5 g of water and 0.1 g of N,N,N,N-tetramethyl(bis(2-aminoethyl)-methylamine (Jeffcat® PMDETA from Huntsman Corp.) are added to the resulting mixture and a stable emulsion is produced by means of a high-speed stator-rotor stirring device (Ultraturrax®).

4.06 g of polymeric MDI (Voranate® M220) are added to this mixture and are mixed with the emulsion by means of a high-speed stator-rotor stirring device (Ultraturrax®, 30 sec. at 15,000 rpm). After about 30 sec., an exothermic reaction and spontaneous foam formation commences. The foam formation is concluded after about 2 minutes, while the evolution of heat continues for about another 1 minute and then slowly abates. The volume of the foam is 4-6 times the initial volume. A flexible, elastic foam having a very fine pore structure is obtained.

1-13. (canceled)

14. A process for the preparation of an organopolysiloxane polyurethane, polyurea, or polyurethaneurea foam, comprising:
a) reacting at least one linear or branched organopolysiloxane bearing terminal groups of the formula (2)
—O—SiR¹₂—OH (2)
with at least one cyclic organosilicon compound comprising structural elements of the formula (3)
—[SiR¹₂—R³—Y]ₖ— (3)
to form a linear or branched organopolysiloxane (A) which contains at least 95% on average of terminal aminoalkyl or hydroxyalkyl groups of the formula (1)
—O—SiR¹₂—O—SiR¹₂—R³-Z (1);
b) reacting organopolysiloxane(s) (A) with an isocyanate component comprising at least one diisocyanate, polyisocyanate, or mixture thereof, and
c) foaming in the presence of at least one blowing agent to form an organopolysiloxane polyurethane or polyurethaneurea foam,
wherein
R¹ each independently is a monovalent, unsubstituted or —CN or halogen-substituted
C₁-C₁₂-hydrocarbon radical in which one or more nonadjacent methylene units can be replaced by —O— units,
R³ is a divalent, unsubstituted or cyano- or halogen-substituted C₁-C₁₂-hydrocarbon radical,
Z is an OH or NH₂ group,
Y is an oxygen atom or an NR⁴ radical,
R⁴ is a hydrogen atom or a radical of the formula (3) in which k is 1 and Y is an NH₂ group, and
k is an integer from 1 to 1,000.

15. The process of claim 14, wherein organopolysiloxane (A) contains 99% on average of terminal groups of the formula (1).

16. The process of claim 14, wherein all Z are —OH.

17. The process of claim 14, wherein all Z are —NH₂.

18. The process of claim 15, wherein all Z are —NH₂.

19. The process of claim 14, wherein some Z are —OH and the remaining Z are —NH₂.

20. The process of claim 15, wherein some Z are —OH and the remaining Z are —NH₂.

21. The process of claim 14, wherein at least one blowing agent is a chemical blowing agent.

22. The process of claim 15, wherein at least one blowing agent is a chemical blowing agent.

23. The process of claim 14, wherein at least one blowing agent is a physical blowing agent.

24. The process of claim 14, wherein the organopolysiloxane A contains from 5 to 100 siloxy units.

25. The process of claim 14, wherein the organosilicon compound(s) of the formula (3) include at least one of the formulae 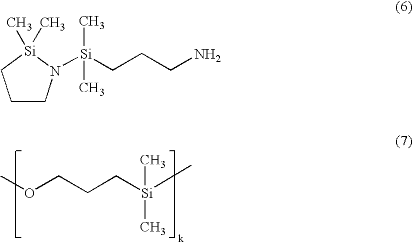
where
k is an integer of at least 2.

26. The process of claim 14, wherein following a synthesis for the organopolysiloxane (A), free Si—OH groups are not detectable by ¹H-NMR and ²⁹Si-NMR.

27. The process of claim 14, wherein water is employed as a chemical blowing agent, and prior to the reaction of the organopolysiloxane (A) with the isocyanate component, the organopolysiloxane (A) and water are emulsified with each other.

28. The process of claim 14, wherein the isocyanate component is employed in stoichiometric excess and reacted with organopolysiloxane (A) to form an isocyanate-terminated prepolymer, and the isocyanate-terminated prepolymer is then formed.

29. The process of claim 28, wherein the prepolymer is admixed with a physical blowing agent and a one-component foamable mixture curable in the presence of atmospheric moisture.

30. The process of 14, further comprising admixing the organopolysiloxane (A) with at least me alcohol or amine having from 2 to 5 isocyanate-reactive —NH₂ or —OH groups.

31. The process of claim 14, further comprising reacting the organopolysiloxanes (A) with the isocyanate component in the presence of a urethane group.
